(19) United States
(12) Patent Application Publication
(10) Pub. No.: US 2002/0118684 A1
(43) Pub. Date: Aug. 29, 2002

(54) ATM header conversion circuit and method

(75) Inventors: Mikihito Sugiura, Yokohama-shi (JP); Yasuhiro Aoyama, Tokyo (JP)

Correspondence Address: CONNOLLY BOVE LODGE & HUTZ LLP, SUITE 800, 1990 M STREET NW, WASHINGTON, DC, 20036-3425, US

(73) Assignee: MATSUSHITA ELECTRIC INDUSTRIAL CO., LTD., Osaka (JP)

(21) Appl. No.: 10/080,406

(22) Filed: Feb. 25, 2002

(30) Foreign Application Priority Data
Feb. 28, 2001 (JP) 2001-55849

(51) Int. Cl. H04L 12/28

(52) U.S. Cl. 370/395.71; 370/389

(57) ABSTRACT

An ATM header conversion circuit for realizing bidirectional header conversion through the use of a simple arrangement using only one entry data storage device. The entry data storage device stores bidirectional header data in a state associated with each of a plurality of addresses. The ATM header conversion circuit partially collates inputted header data with one of entry data groups placed in the entry data storage device on the basis of mask bits which designate the collation bit positions of the inputted header data, and outputs, as new header data, the header data of the other entry data group at the addresses where the partial collation shows coincidence.

### BACKGROUND OF THE INVENTION

1) Field of the Invention

The present invention relates to an ATM cell header conversion circuit (which will be referred to hereinafter as an “ATM header conversion circuit) and method for conversion of ATM (Asynchronous Transfer Mode) cell headers (ATM headers).

2) Description of the Related Art

As conventional ATM header conversion, there has been known a RAM system using a RAM designed to store data after conversion (converted data) in the form of a header conversion table in a state addressable as a function of data before the conversion (non-converted data). In this case, although an ATM cell, a header thereof and each field in the header are defined on the basis of a fixed length, in fact an ATM network imposes limitation on each field length in the header, particularly, on the field length of each of an 8-bit allocated VPI (Virtual Path Identifier) and a 16-bit allocated VCI (Virtual Channel Identifier). For this reason, the RAM system uses only a memory capacity corresponding to the actual number of connections, which leads to ineffective use of the memory space.

As an approach to remove such limitation, for example, there has been known the “ATM Header Conversion With CAM” written by Nakayama, et al. in “Electronic Information Communications Academic Society Meeting B-521”, 1996. A circuit according to this approach comprises a CAM (Content Addressable Memory) 250 and a RAM 251, as shown in FIG. 19. The addresses in the CAM 250 and the RAM 251 are set up on a one-on-one basis, and non-converted and converted data are stored in each of the CAM 250 and the RAM 251. Moreover, an address 201 is derived from inputted header data (A-side header data) 200 from a first ATM network by means of the CAM 250 while the corresponding header data (B-side header data) 202 to be outputted to a second ATM network is read out from the RAM 252 on the basis of the generated address.

With the employment of such an ATM header conversion circuit, the determination on the number of connections to be used allows the use of only the corresponding memory capacity, and does not impose limitation on the number of bits to be allocated to VPI plus VCI.

However, in the case of the foregoing conventional header conversion circuit, for the header conversion from the first ATM network to the second ATM network and the header conversion from the second ATM network to the first ATM network to be made in a state where header data are placed independently in the respective ATM networks, a need for two CAMs 250 and two RAMs 251 exists, which leads to enlargement of the circuit scale and requires the monitoring of the matching between the connection information put in the two storage means. Moreover, there is a problem in that it takes time to conduct the header conversion processing, for that the address information on the RAM 251 is read out from the CAM 250 before the access to the RAM 251.

### SUMMARY OF THE INVENTION

The present invention has been developed with a view to solving the above-mentioned problems peculiar to the conventional system, and it is therefore an object of the invention to provide an ATM header conversion circuit and method capable of realizing fast bidirectional header conversions with a simple circuit arrangement through the use of one entry data storage means.

For this purpose, in accordance with a first aspect of the present invention, there is provided an ATM header conversion circuit comprising entry data storage means for storing, as entry data, first and second ATM header data paired at each of a plurality of addresses, partial collation means for partially collating inputted header data with one of the first and second ATM header data stored in the entry data storage means for each address on the basis of a designation signal representative of a collation position of the ATM header data being converted and for outputting a collation result for each address, address extraction means for extracting, on the basis of the collation result for each address, an address in the entry data storage means at which the collation result shows coincidence (agreement), and header outputting means for outputting, as converted ATM header data, the other of the first and second ATM header data at the address extracted by the address extraction means from the entry data storage means.

This enables the fast bidirectional header conversions with a simple circuit arrangement through the use of one entry data storage means.

In this case, in this ATM header conversion circuit, the designation signal representative of the collation position of the first or second ATM header data is generated in units of bits, and the partial collation means collates the inputted header data with one of the first and second ATM header data in units of bits.

In addition, in this ATM header conversion circuit, the designation signal representative of the collation position of the first or second ATM header data is generated in unit of word, and the partial collation means collates the inputted header data with one of the first and second ATM header data in unit of word.

This enables the number of bits to be inputted to the ATM header conversion circuit, indicative of a retrieving direction, to be controllable with no dependence on a header length.

In this case, it is also appropriate that the ATM header conversion circuit further comprises entry data partial-readout means for partially reading out, in the form of one word, one of said first or second ATM header data stored in said entry data storage means on the basis of a designation signal generated in unit of word and a readout address in said entry data storage means specified from the external.

This enables fast readout from the entry data storage means.

Furthermore, it is also appropriate that the ATM header conversion circuit further comprises entry data partial-write means for partially writing, in the form of one word, one of first and second ATM header data in said entry data storage means on the basis of a designation signal generated in unit of word and a write address in the entry data storage means.

This enables fast writing in the entry data storage means.

Moreover, in the foregoing ATM header conversion circuit, it is also appropriate that the number of words each to be used for the designation signal is made variable.

This permits dealing with a system alteration such as addition/deletion of information about connections without changing the circuit arrangement.

Still moreover, in the foregoing ATM header conversion circuit, it is also appropriate that the number of bits to be allocated to one word is made variable.

This permits coping with a system alteration such as expansion of the number of bits for use in VPI/VCI without changing the circuit arrangement.

Yet moreover, in the foregoing ATM header conversion circuit, it is also appropriate that the number of words each to be used for the designation signal and the number of bits to be allocated to one word are made variable.

This can cope with a system alteration without changing the circuit arrangement.

In addition, in the foregoing ATM header conversion circuit, it is also appropriate that the header outputting means is made to output, in addition to the converted ATM header data, the corresponding address in the entry data storage means.

This enables simultaneously outputting the address and header data corresponding to the inputted header, thereby providing the corresponding header data fast.

Furthermore, in accordance with a second aspect of the present invention, there is provided an ATM header conversion circuit comprising entry data storage means for storing ATM header data, which remain unchanged irrespective of conversion, as entry data in a state associated with first and second addresses paired, full collation means for fully collating inputted header data with the ATM header data, stored in the entry data storage means, at each of the pairs of first and second addresses to output a collation result at each of the pairs of first and second addresses, address extraction means for extracting, on the basis of the collation result at each of the pairs of first and second addresses, the first and second addresses in the entry data storage means at which the collation result shows coincidence, converted ATM header storage means for previously storing the ATM header data after conversion in a state associated with the first and second addresses in the entry data storage means, and readout means for selecting one of the first and second addresses extracted in the address extraction means on the basis of a direction of the ATM header data conversion to read out the ATM header data at the selected address from the converted ATM header storage means.

According to this configuration, since duplicated header data are stored in one entry data storage means, in a case in which many header data are used in a duplicated state on both the sides, the ATM header conversion becomes feasible in a circuit scale reduced to approximately half as compared with that of the arrangement in which a storage means is used for each conversion direction.

In this case, it is also appropriate that the ATM header conversion direction is designated according to a network through which header data is inputted to the full collation means.

This can realize bidirectional header conversion with a simple circuit arrangement through the use of one entry data storage means in a state where the circuit scale is reduced to approximately half as compared with an arrangement in which a different storage means is provided with respect to each of both the directions.

It is also appropriate that this ATM header conversion circuit further comprises a connection whose one side has a plurality of divided ports so that the addresses in the entry data storage means correspond to the numbers of the ports, respectively.

Since the addresses and the port numbers are associated with each other, without newly adding a bit for the port number, it is possible to provide a connection port number and an address output simultaneously.

In addition, it is also appropriate that this ATM header conversion circuit further comprises a connection whose one side has a plurality of divided ports, and the addresses in the entry data storage means include the numbers of the ports, respectively.

Since the port numbers are further stored in the entry data storage means, this arrangement enables one entry data storage means to manage bidirectional header data and port numbers in a state associated with each other.

In this case, header data inputted through one non-divided side of the connection is collated on the basis of a signal representative of a collation position of the ATM header data being converted, and the ATM header data converted is outputted to one of the plurality of ports of the other side of the connection on the basis of the port number included in the address.

This enables outputting a port number and the corresponding header data concurrently with respect to the input of header data from the non-divided side.

Moreover, in this case, the port numbers are added to the ATM header data on the divided side of the connection and stored in the entry data storage means, and the ATM header data and the port numbers are partially collated on the basis of the signal representative of the collation position of the ATM header data being converted.

Since the partial coincidence collation is also made with respect to the input from the connection port, this arrangement enables the corresponding header data to be outputted with respect to a port number and header data from the divided side.

Still moreover, the port numbers are added to the ATM header data on the divided side of the connection and stored in the entry data storage means while the ATM header data on the non-divided side of the connection is stored intact, and in a case in which the ATM header data is inputted through the divided side of the connection, the ATM header data, together with the port number, is partially collated on the basis of the signal representative of the collation position of the ATM header data being converted, while in a case in which the ATM header data is inputted through the non-divided side of the connection, only the inputted ATM header data undergoes partial collation.

Since the header outputting means outputs the port number simultaneously and the partial coincidence collation means makes the partial coincidence collation with respect to the input from the connection port, this enables the bidirectional ATM header conversion from the divided side to the non-divided side and vice versa.

Furthermore, in the foregoing ATM header conversion circuit, it is also appropriate that connection information is added to the entry data and stored in the entry data storage means.

This enables one entry data storage means to manage the bidirectional header data and some connection information such as band control information in a state associated with each other.

In this case, the connection information, together with the converted header data corresponding to the inputted header data, is outputted on the basis of the signal representative of the collation position of the ATM header data being converted.

Thus, it is possible to output the corresponding header data and the connection information simultaneously.

Still furthermore, in the foregoing ATM header conversion circuit, it is also appropriate that, of the ATM header data stored in the entry data storage means, a VPI/VCI inhibited in the system is set as an initial value.

Since data which does not show the partial coincidence is always set as an initial value of the entry data, it is possible to eliminate the need for an entry mask bit representative of information on the occurrence or no occurrence of registration to be placed in the entry data storage means, thus leading to a reduction of circuit scale.

Yet furthermore, in the foregoing ATM header conversion circuit, it is also appropriate that, of the ATM header data stored in the entry data storage means, a VPI/VCI which does not require registration is set as an initial value.

Since data which does not show the partial coincidence is always set as an initial value of the entry data, in like manner, it is possible to eliminate the need for an entry mask bit representative of information on the occurrence or no occurrence of registration to be placed in the entry data storage means, thus leading to a reduction of circuit scale.

In addition, it is also appropriate that the foregoing ATM header conversion circuit further comprises first multiple-coincidence counting means placed in an odd-number position for counting the coincidences with a plurality of entry data on the basis of the collation result on each entry data stored in the entry data storage means and the last multiple-coincidence information on the entry data and further for communicating the count result to the next multiple-coincidence counting means, and second multiple-coincidence counting means placed in an even-number position for detecting the coincidences with a plurality of entry data on the basis of the collation result on each entry data stored in the entry data storage means, the last multiple-coincidence information and the last-but-one multiple-coincidence information, and further for communicating the detection result to the next multiple-coincidence counting means and the next-but-one multiple-coincidence counting means.

This enables shortening the maximum gate delay time in detecting the multiple-coincidence of entry data stored in the entry data storage means. Concretely, since the multiple-coincidence information is handed over to the next-but-one stage, it is possible to suppress the maximum gate delay time to approximately (1/2×E+2)×T where E represents the number of entries and T denotes a delay time required from the input to the output in one multiple-coincidence counting means.

Still additionally, it is also appropriate that the foregoing ATM header conversion circuit further comprises first multiple-coincidence counting means placed in other than position in multiples of a natural number N for detecting the coincidences with a plurality of entry data on the basis of the collation result on each entry data stored in the entry data storage means and the last multiple-coincidence information on the entry data and further for communicating the detection result to the next multiple-coincidence counting means, and second multiple-coincidence counting means placed in a multiple-of-N position for detecting the coincidences with a plurality of entry data on the basis of the collation result on each entry data stored in the entry data storage means, the last multiple-coincidence information and the last-but-N-1 multiple-coincidence information, and further for communicating the detection result to the next multiple-coincidence counting means and the next-but-N-1 multiple-coincidence counting means.

This also enables shortening the maximum gate delay time in detecting the multiple-coincidence of entry data stored in the entry data storage means. Concretely, since the multiple-coincidence information is handed over to the next-but-N-1 stage, it is possible to suppress the maximum gate delay time to approximately (1/N×E+2×N−2)×T.

Yet additionally, it is also appropriate that the foregoing ATM header conversion circuit further comprises first multiple-coincidence counting means placed in other than position in the Mth power of 2 (M represents a natural number) for detecting the coincidences with a plurality of entry data on the basis of the collation result on each entry data stored in the entry data storage means and the last multiple-coincidence information on the entry data and further for communicating the detection result to the next multiple-coincidence counting means, and second multiple-coincidence counting means placed in a position in the Mth power of 2 for detecting the coincidences with a plurality of entry data on the basis of the collation result on each entry data stored in the entry data storage means, the last multiple-coincidence information and the last-but-2^{T}-1 (T represents all natural numbers below M) multiple-coincidence information, and further for communicating the detection result to the next multiple-coincidence counting means and the next-but-2^{T}-1 multiple-coincidence counting means.

This also enables shortening the maximum gate delay time in detecting the multiple-coincidence of entry data stored in the entry data storage means. Concretely, in this case, it is possible to suppress the maximum gate delay time to approximately log₂ E×T.

Moreover, it is also appropriate that the foregoing ATM header conversion circuit further comprises first multiple-coincidence counting means placed in other than position in the Mth power of N (M, N represent a natural number) for detecting the coincidences with a plurality of entry data on the basis of the collation result on each entry data stored in the entry data storage means and the last multiple-coincidence information on the entry data and further for communicating the detection result to the next multiple-coincidence counting means, and second multiple-coincidence counting means placed in a position in the Mth power of N for detecting the coincidences with a plurality of entry data on the basis of the collation result on each entry data stored in the entry data storage means, the last multiple-coincidence information and the last-but-N^{T}-1 (T represents all natural numbers below M) multiple-coincidence information, and further for communicating the detection result to the next multiple-coincidence counting means and the next-but-N^{T}-1 multiple-coincidence counting means.

This also enables shortening the maximum gate delay time in detecting the multiple-coincidence of entry data stored in the entry data storage means. Concretely, in this case, it is possible to shorten the maximum gate delay time to approximately (log_{N} E+2×N)×T.

In the present invention, it is also appropriate that conversion of an ATM header in an optical subscriber transmission system is made through the use of the aforesaid ATM header conversion circuits.

This realizes fast ATM header conversion in an optical subscriber transmission system through the use of a simple arrangement and a relatively small scale.

In this case, it is also appropriate that first and second ATM header data are stored in a state paired with respect to a plurality of addresses, and inputted header data is collated with one of the stored first and second ATM header data at each address on the basis of a collation position of the ATM header data being converted which forms one of the first and second ATM header data, and the other of the first and second ATM header data at the address where the collation result shows the coincidence is set as converted ATM header data.

This realizes fast bidirectional header conversion through the use of one entry data storage means and a simple circuit.

### BRIEF DESCRIPTION OF THE DRAWINGS

Other objects and features of the present invention will become more readily apparent from the following detailed description of the preferred embodiments taken in conjunction with the accompanying drawings in which:

FIG. 1 is a block diagram showing an ATM header conversion circuit according to a first embodiment of the present invention;

FIG. 2 is an illustration useful for explaining an ATM header conversion operation in an A-side to B-side direction according to the first embodiment of the present invention;

FIG. 3 is an illustration useful for explaining an ATM header conversion operation in an A-side to B-side direction according to a second embodiment of the present invention;

FIG. 4 is a block diagram useful for explaining an entry data write operation according to a third embodiment of the present invention;

FIG. 5 is a block diagram useful for explaining an entry data readout operation according to a fourth embodiment of the present invention;

FIG. 6 is a block diagram useful for explaining an ATM header conversion circuit according to a sixth embodiment of the present invention;

FIG. 7 is a block diagram useful for explaining an ATM header conversion circuit according to a seventh embodiment of the present invention;

FIG. 8 is an illustration useful for explaining an ATM header conversion operation in an A-side to B-side direction according to the seventh embodiment of the present invention;

FIG. 9 is a block diagram showing a multi-port system according to an eighth embodiment of the present invention;

FIG. 10 is an illustration useful for explaining addresses in an entry data storage means according to the eighth embodiment of the present invention;

FIG. 11 is an illustration useful for explaining entry data in an entry data storage means according to a ninth embodiment of the present invention;

FIG. 12 is an illustration useful for explaining entry data in an entry data storage means according to a tenth embodiment of the present invention;

FIG. 13 is a block diagram showing an ATM header conversion circuit according to an eleven th embodiment of the present invention;

FIG. 14 is a block diagram showing an ATM header conversion circuit according to a twelfth embodiment of the present invention;

FIG. 15 is a block diagram showing the detection of multiple-coincidence according to a thirteenth embodiment of the present invention;

FIGS. 16A and 16B are illustrations useful for explaining multiple-coincidence operations according to the thirteenth embodiment of the present invention, and show operations of first and second multiple-coincidence counting means illustrated in FIG. 15, respectively;

FIG. 17 is a block diagram useful for explaining the detection of multiple-coincidence according to fourteenth embodiment of the present invention;

FIG. 18 is an illustration useful for explaining an operation of a second multiple-coincidence counting means shown in FIG. 17; and

FIG. 19 is a block diagram showing a conventional ATM header conversion circuit.

### DESCRIPTION OF THE PREFERRED EMBODIMENTS

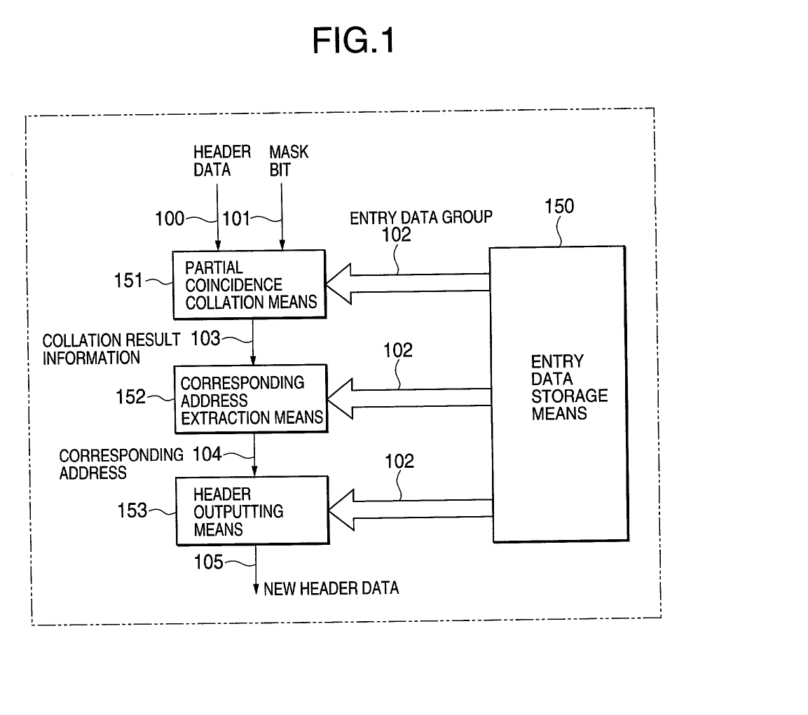

Embodiments of the present invention will be described hereinbelow with reference to FIGS. 1 to 18.

First Embodiment

FIG. 1 shows an arrangement of an ATM header conversion circuit according to a first embodiment of the present invention.

As FIG. 1 shows, an ATM header conversion circuit according to this embodiment is made up of an entry data storage means 150, a partial coincidence collation means 151, a corresponding address extraction means 152 and a header outputting means 153. In this case, an ATM cell comprises a 5-byte header and a 48-byte payload (user data), and has a fixed length of 53 bytes in total, while a header comprises information: 4-bit GFC (General Flow Control), an 8-bit VPI (Virtual Path Identifier), a 16-bit VCI (Virtual Channel Identifier), a 3-bit PT (Payload Type), a 1-bit CLP (Cell Loss Priority) and an 8-bit HEC (Header Error Control). In fact, the connections corresponding to the total number of bits are not put simultaneously to use.

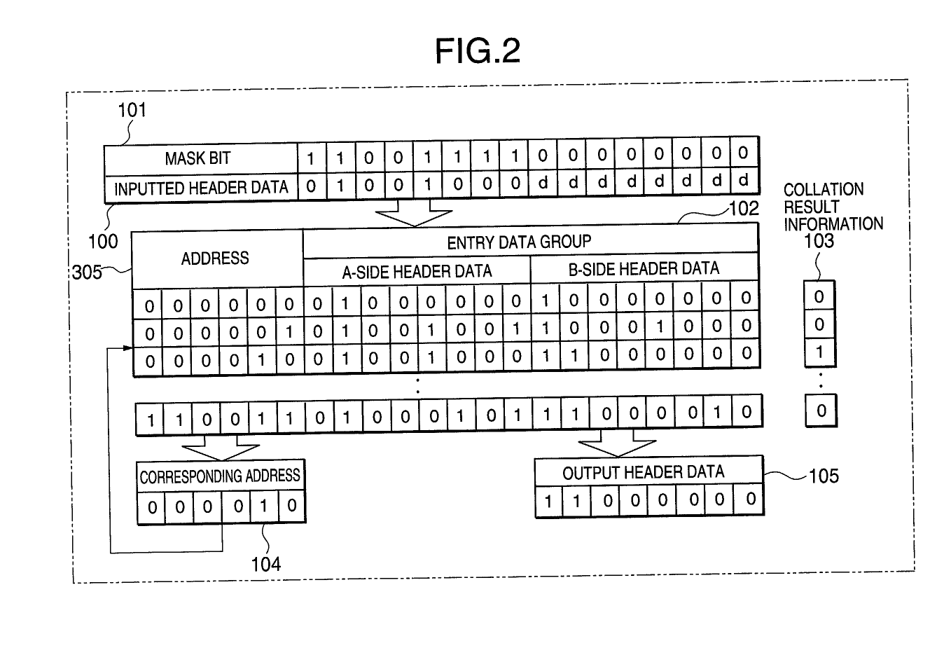

As FIG. 2 shows, the entry data storage means 150 stores bidirectional (A-side, B-side) header data in a state associated with each other with respect to each of a plurality of addresses 305. When inputted header data 100 (for example, A-side header data) and a mask bit 101 designating a collation bit position of the header data 100, the partial coincidence collation means 151 partially collates the inputted header data 100 with one of the entry data groups 102 placed (registered) in the entry data storage means 150 and outputs, to the corresponding address extraction means 152, collation result information 103 identical in number of bits to the plurality of entry data groups 102 and representative of the coincidence contents with the registered entry data (indicative of which of the entry data registered coincides).

The corresponding address extraction means 152 extracts a corresponding address 104 of the entry data storage means 150 from the entry data group 102 on the basis of the collation result information 103 outputted from the partial coincidence collation means 151 to output it to the header outputting means 153. The header outputting means 153 outputs, as output header data, new header data 105 pertaining to the other entry data group 102, stored in the entry data storage means 150, on the basis of the corresponding address 104 outputted from the corresponding address extraction means 152.

Referring to FIG. 2, a detailed description will be given hereinbelow of a data flow for the ATM header conversion. In FIG. 2, each of the A-side and B-side header data lengths being converted partially is set at 8 bits, and the number of entries is set at 64. As the entry data groups 102, 64 A-side header data and B-side header data are paired and stored in a state associated with addresses 305. Upon receipt of A-side header data 100 and mask bits 101 for designating storage positions of the A-side header data 100, the partial coincidence collation means 151 simultaneously makes comparison on the 64 A-side entry data and outputs (sets) “1” to the bit of the collation result information 103 corresponding to the entry data put to the comparison.

The corresponding address extraction means 152 obtains the corresponding address 104 on the basis of this collation result information 103, and the header outputting means 153 outputs new header data 105 through the use of the corresponding address 104. In the example of FIG. 2, the 8-bit inputted header data 100 is “01001000”, and the 16-bit mask bits 101 are “1100111100000000”.

In this case, partial coincidence takes place between the high-order 8-bit A-side header data 100 and the third-line entry data of the entry data group 102. Accordingly, the corresponding address 104 of “000010” is acquired on the basis of the collation result information 103 representative of the information on the third-line coincidence, and the B-side header data “11000000” is outputted on the basis of this corresponding address 104 (“000010”).

With the ATM header conversion circuit thus arranged, when the header data (VPI/VCI) are arbitrarily allocated on the A-side and the B-side, the use of only one entry data storage means 150 enables the ATM header conversion in a direction from the A-side to the B-side. The realization of the ATM header conversion by only one entry data storage means 150 permits a relatively small circuit scale and allows the connection information to be registered at one time.

Second Embodiment

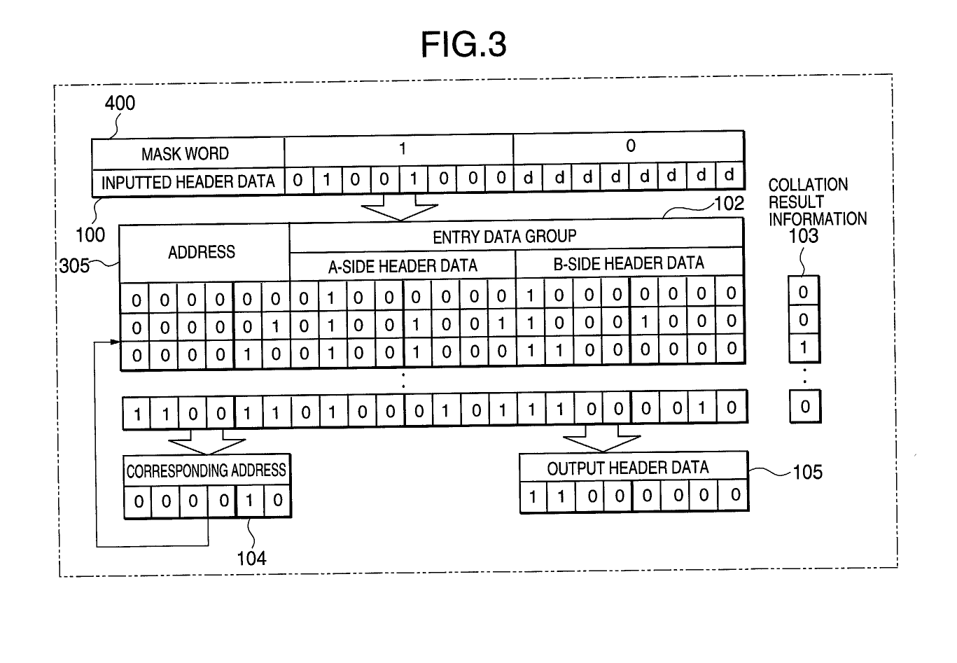

A second embodiment of the present invention will be described hereinbelow with reference to FIGS. 1 and 3. In the second embodiment, the entry data groups 102 shown in FIG. 2 are logically divided into units of words (8 bits) for the A-side and B-side header data, and for the designation of the collation positions, mask words 400 are used in place of the mask bits 101 shown in FIG. 2. When A-side header data of the entry data groups 102 is specified with the mask word 400, this arrangement according to the second embodiment operates the same as in the designation by the mask bits 101 corresponding to the length of the A-side header data.

As compared with the masking in bit units according to the first embodiment, this arrangement enables the reduction of the number of bits of a mask signal for designating the bits to be converted. In addition, as compared with the mask bits 101 according to the first embodiment, it is possible to suppress the number of bits of the mask words 400 indicative of the retrieving direction, inputted to the ATM header conversion circuit, without depending upon header length.

Third Embodiment

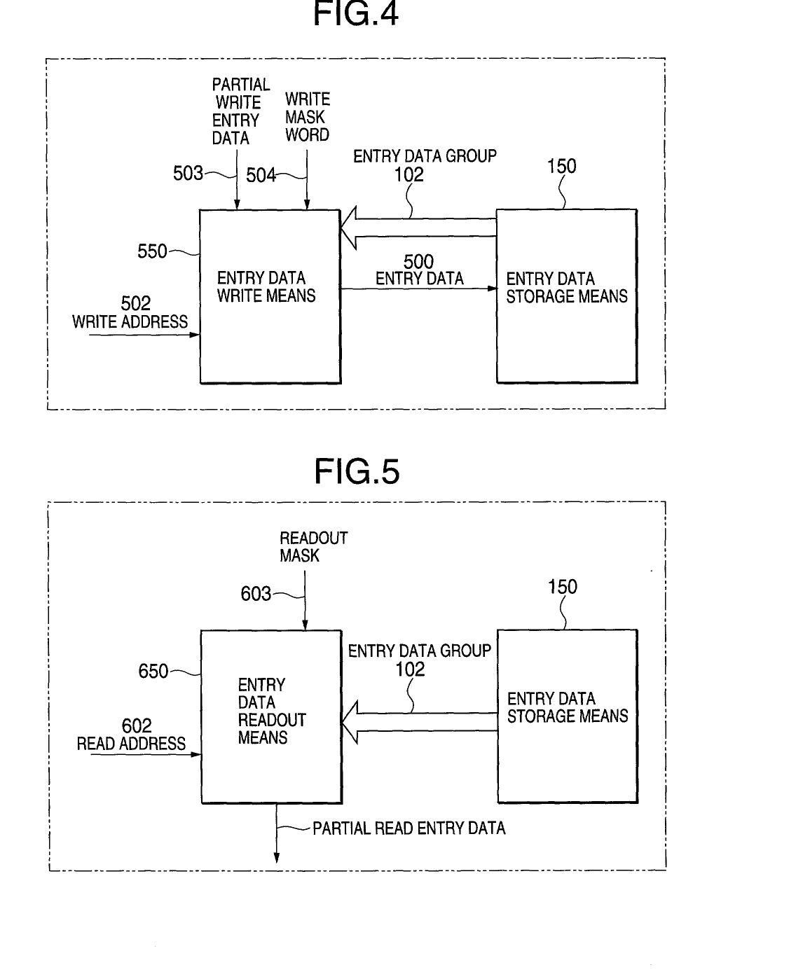

An entry data write operation according to a third embodiment of the present invention will be described hereinbelow with reference to FIG. 4. As FIG. 4 shows, for the entry data write operation, an arrangement is made up of an entry data write means 550 and an entry data storage means 150 shown in FIG. 1.

In this arrangement, when partial write entry data 503, a write mask word 504 for designation of write bits and a write address are given from the external, generally from a CPU, the entry data write means 550 is made to write the partial write entry data 503 in bit positions, designated by the write mask work 504, of the entry data corresponding to the specified write address 502 in the entry data groups 102 stored in the entry data storage means 150 as shown in FIGS. 2 or 3. In consequence, this entry data 503 is stored as entry data 500 in the entry data storage means 150.

This arrangement allows data writing to be made partially in the entry data storage means 150, which reduces the number of bits and lessens the load imposed on a CPU.

Fourth Embodiment

An entry data readout operation according to a fourth embodiment of the present invention will be described hereinbelow with reference to FIG. 5. For the entry data readout operation, an arrangement is made up of an entry data readout means 650 and an entry data storage means 150.

Upon receipt of a readout mask word 603 and a read address 602 from the external, usually from a CPU, the entry data readout means 650 reads out only a word designated by the readout mask word 603, which is the entry data corresponding to the specified read address 602 in the entry data groups 102 stored in the entry data storage means 150 as shown in FIGS. 2 or 3.

This permits partial readout to be made from the entry data storage means 150 so that fast readout of only the data necessary for a CPU becomes feasible.

Fifth Embodiment

In a fifth embodiment of the present invention, in FIG. 3, the words for the designation of the data positions are made variable in number in accordance with a designation from the external. That is, the partitions among the words are made variable from the external.

This enables the ATM header conversion without changing the circuit even if an alteration of the system specification, concretely, a change in the number of bits for VPI/VCI to be used, takes place.

Sixth Embodiment

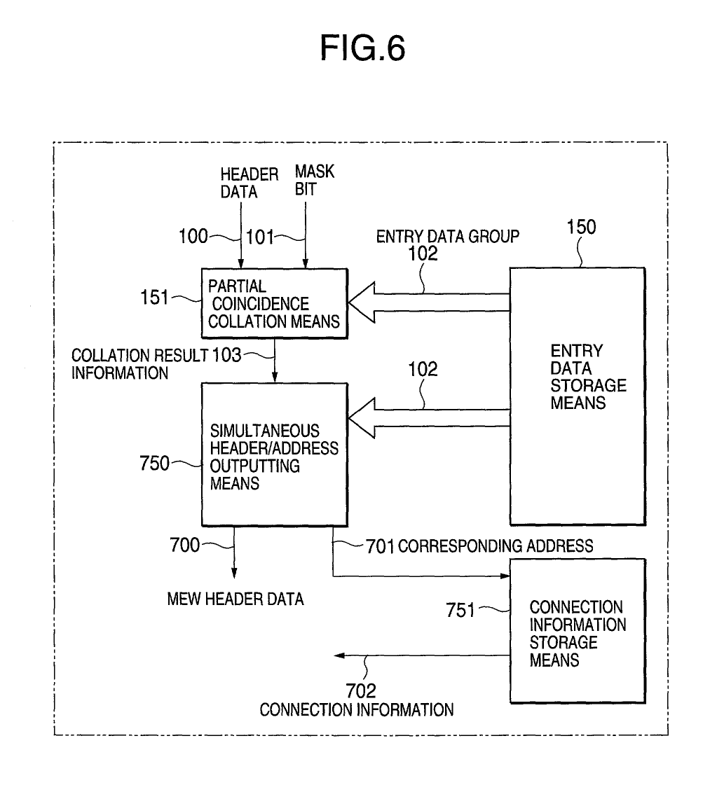

A sixth embodiment of the present invention will be described hereinbelow with reference to FIG. 6. FIG. 6 shows an arrangement for an ATM header conversion. As FIG. 6 shows, this arrangement comprises an entry data storage means 150 and partial coincidence collation means 151 shown in FIG. 1, and further comprises a simultaneous header/address outputting means 750 and a connection information storage means 751.

In the connection information storage means 751, band information on the connections and connection information 702 such as registration status are stored in a one-to-one correspondence with address in the entry data storage means 150. The simultaneous header/address outputting means 750 is made to simultaneously output new header data 700 paired with inputted header data 100 and the corresponding address 701 through the use of collation result information 103 acquired by the partial coincidence collation means 151 according to a method similar to that according to the above-described first embodiment. On the basis of this corresponding address 701, the connection information 702 is read out from the connection information storage means 751.

This enables obtaining the new header data 700 corresponding to the inputted header data 100 and further the relevant connection information 702 at a high speed through the use of a simple arrangement.

Seventh Embodiment

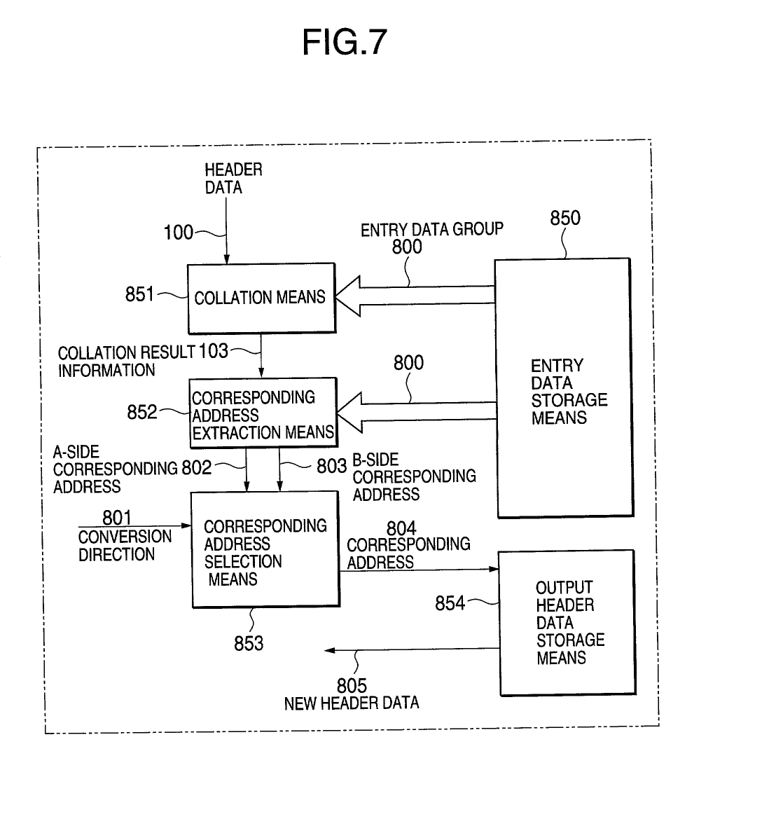

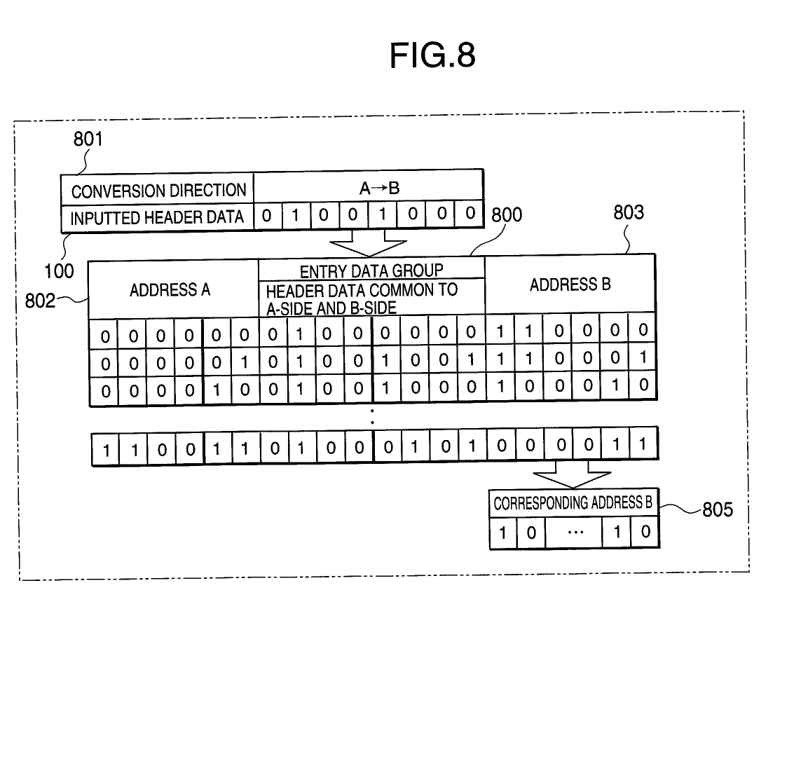

Referring to FIGS. 7 and 8, a description will be given hereinbelow of an ATM header conversion circuit according to a seventh embodiment of the present invention. As FIG. 7 shows, the ATM header conversion circuit is made up of an entry data storage means 850, a collation means 851, a corresponding address extraction means 852, a corresponding address selection means 853 and an output header data storage means 854.

Unlike the cases shown in FIGS. 2 and 3, the entry data storage means 850 is designed to store an A-side/B-side entry data group 800, including duplication, and A-side corresponding addresses (address A) 802 and B-side corresponding addresses (address B) 803 independent of each other, in an associated condition. That is, in a case in which the same VPI/VCI is given to both the A-side and B-side, the entry data group 800, the A-side corresponding addresses 802 and the B-side corresponding addresses 803 are stored as sets.

The collation means 851 makes full coincidence collation between inputted header data 100 and the entry data group 800 stored in the entry data storage means 850 and outputs collation result information 103 to the corresponding address extraction means 852.

The corresponding address extraction means 852 outputs an A-side corresponding address 802 and a B-side corresponding address 803 to the corresponding address selection means 853 on the basis of the collation result information 103 outputted from the collation means 851.

The corresponding address selection means 853 selects one of the A-side corresponding address 802 and the B-side corresponding address 803 in accordance with a conversion direction 801 of A→B or B→A inputted from the external, and outputs it as a converted corresponding address 804.

The output header data storage means 854 stores corresponding addresses 804 and output header data in a state associated with each other, and outputs new header data 805 corresponding to the corresponding address 804.

That is, when the header data 100, for example, the A-side header data, and the conversion direction “A→B” are given as inputs, it is possible to provide the corresponding B-side header data.

Accordingly, in a system in which many header information exist in a duplicate condition on the A-side and the B-side, the connection numbers are obtainable, even though the circuit scale is reduced to approximately half as compared with an arrangement of an ATM header conversion circuit in which separate storage means are placed on the A-side and the B-side.

Eighth Embodiment

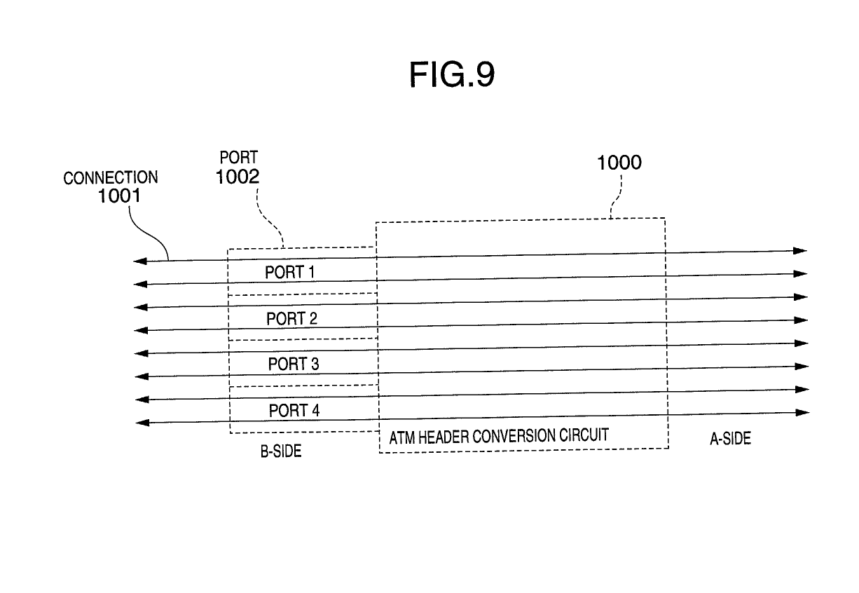

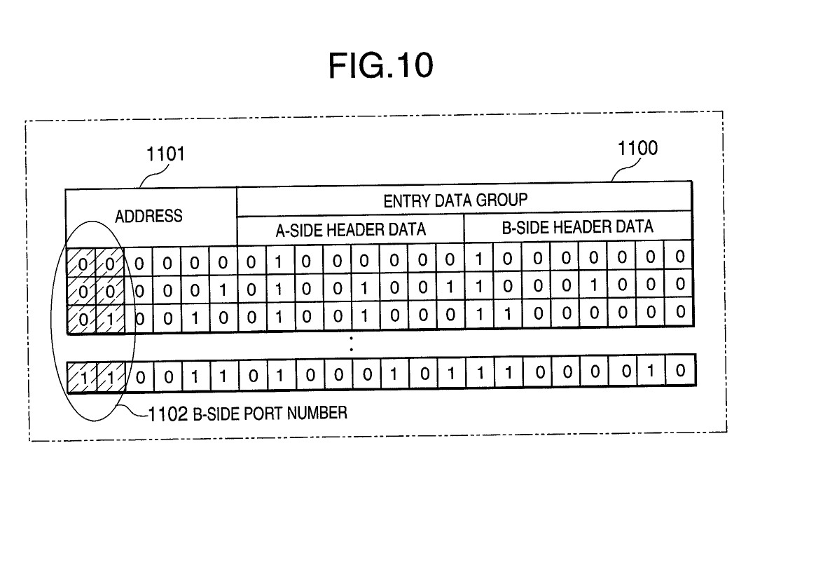

An eighth embodiment of the present invention will be described hereinbelow with reference to FIGS. 9 and 10. FIG. 9 is an illustration of a system in which an A-side or B-side connection 1001 is physically divided into a plurality of ports 1002, and FIG. 10 is an illustration of an example in which a B-side path is divided into four ports.

In this multi-port system, according to the eighth embodiment, partial data (two high-order bits in the illustration) of an address 1101 (six bits in the illustration) associated with an entry data group 1100 is associated with a B-side port number 1102 as shown in FIG. 10.

This permits the determination of an output port for that cell concurrently with conducting the header conversion. This eliminates the need for connection information to be placed in a different storage means, thus contributing to the reduction of circuit scale. In this case, the A-side and the B-side are reversible.

Ninth Embodiment

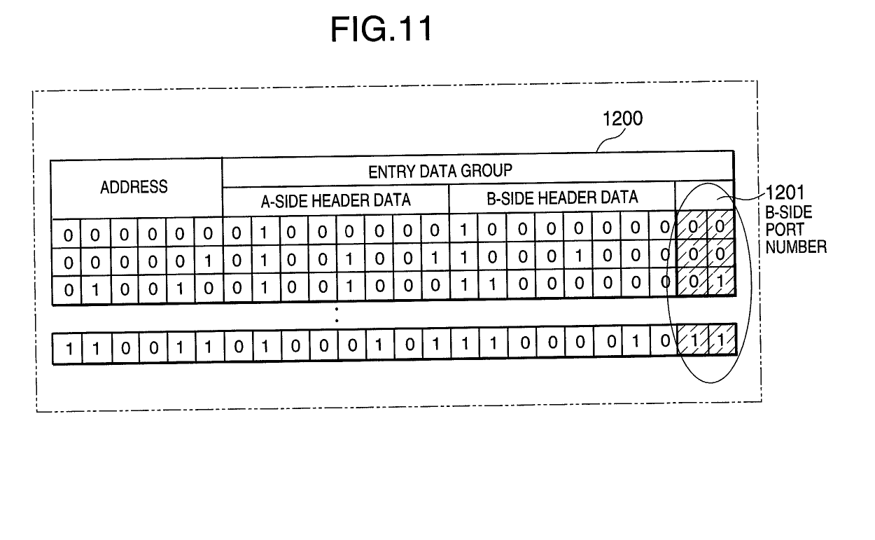

A ninth embodiment of the present invention will be described hereinbelow with reference to FIGS. 9 and 11.

In the multi-port system shown in FIG. 9, B-side port numbers 1201 are added to an entry data group 1200 as shown in FIG. 11. For the header conversion from the A-side to the B-side, a B-side port number 1201 is outputted together with B-side header data. In addition, for the header conversion from the B-side to the A-side, a B-side port number, together with the B-side header data, is added to a bit to be collated.

With this arrangement, the header conversion becomes feasible even in the case of a system in which VPI/VCI are determined independently with respect to each of ports.

Tenth Embodiment

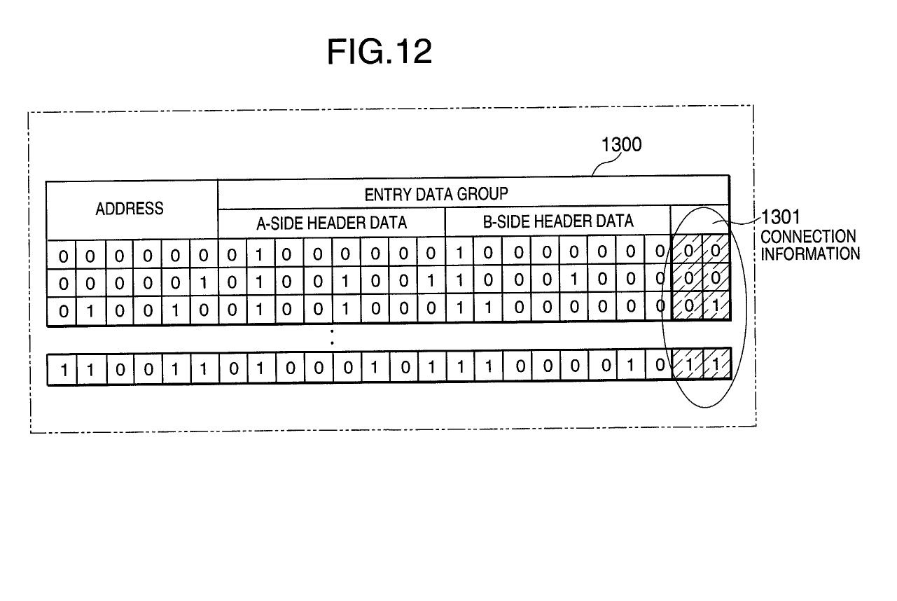

A tenth embodiment of the present invention will be described hereinbelow with reference to FIG. 12. In the tenth embodiment, B-side connection information 1301 is added to an entry data group 1300 as shown in FIG. 12. This connection information 1301 is read out concurrently with the header conversion. In this case, the connection information 1301 signifies, for example, band control information, throughput information and others.

This enables the connection information 1301 to be fast provided at the same time as the header conversion.

Eleventh Embodiment

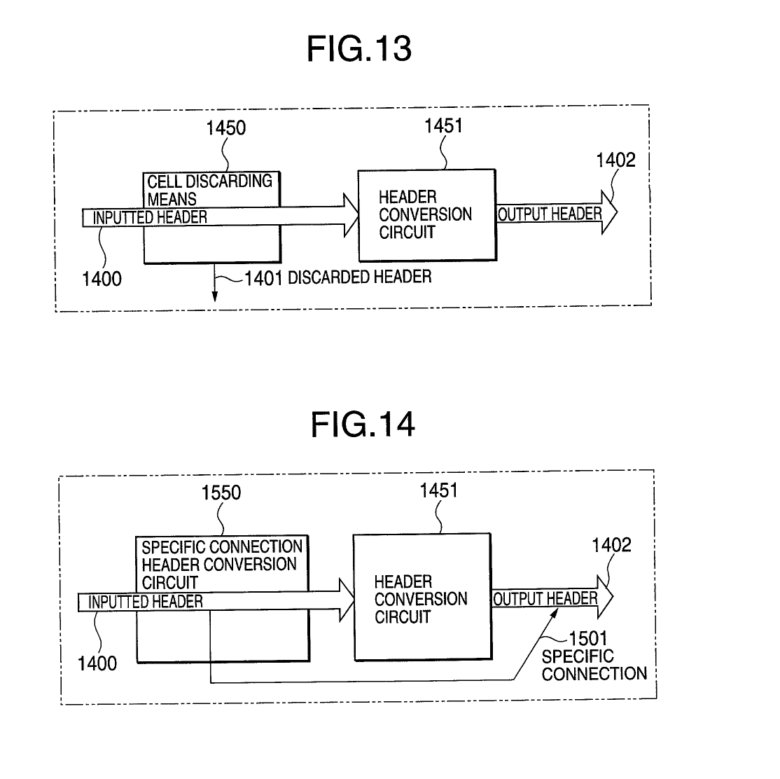

An eleventh embodiment of the present invention will be described hereinbelow with reference to FIG. 13. FIG. 13 is an illustration of an arrangement for ATM header conversion. This arrangement comprises a cell discarding means 1450 and a header conversion circuit 1451.

When header data (discarded header) 1401 of inputted headers 1400, which is rejected as input to the system, is inputted thereto, the cell discarding means 1450 discards that header 1401 without supplying it to the header conversion circuit 1451.

In the header conversion circuit 1451, an initial value of entry data to be stored in an entry data storage means 150 is set to be equal to the value of entry data (pattern of the header data 1401 to be discarded) of a non-registered connection. In this way, an output header 1402 is outputted from the header conversion circuit 1451.

With this arrangement, in the header conversion circuit 1451, all the inputted header data 1400 do not coincide partially with non-registered entry data. This signifies that the header conversion can correctly be made without requiring an entry mask bit representative of the presence or absence of the registration information employed in the conventional CAM.

Twelfth Embodiment

A twelfth embodiment of the present invention will be described hereinbelow with reference to FIG. 14. FIG. 14 is an illustration of an arrangement for ATM header conversion. As FIG. 14 shows, this arrangement comprises a specific connection header conversion circuit 1550 and a header conversion circuit 1451.

The specific connection header conversion circuit 1550 is made to conduct only header conversion on one header data pattern (specific connection 1501) of inputted headers 1400, with the other header data being subjected to header conversion in the header conversion circuit 1451. In addition, in the header conversion circuit 1451, an initial value of entry data stored in an entry storage means 150 is set to be equal to the value of entry data (pattern of header data to be discarded) of a non-registered connection. Thus, an output header 1402 is outputted from the header conversion circuit 1451.

With this arrangement, even in a system in which a cell having a pattern to be discarded particularly does not exist, all the inputted header data 1400 do not coincide partially with non-registered entry data in the header conversion circuit 1451. This signifies that the header conversion can correctly be made without requiring an entry mask bit representative of the presence or absence of the registration information employed in the conventional CAM.

Thirteenth Embodiment

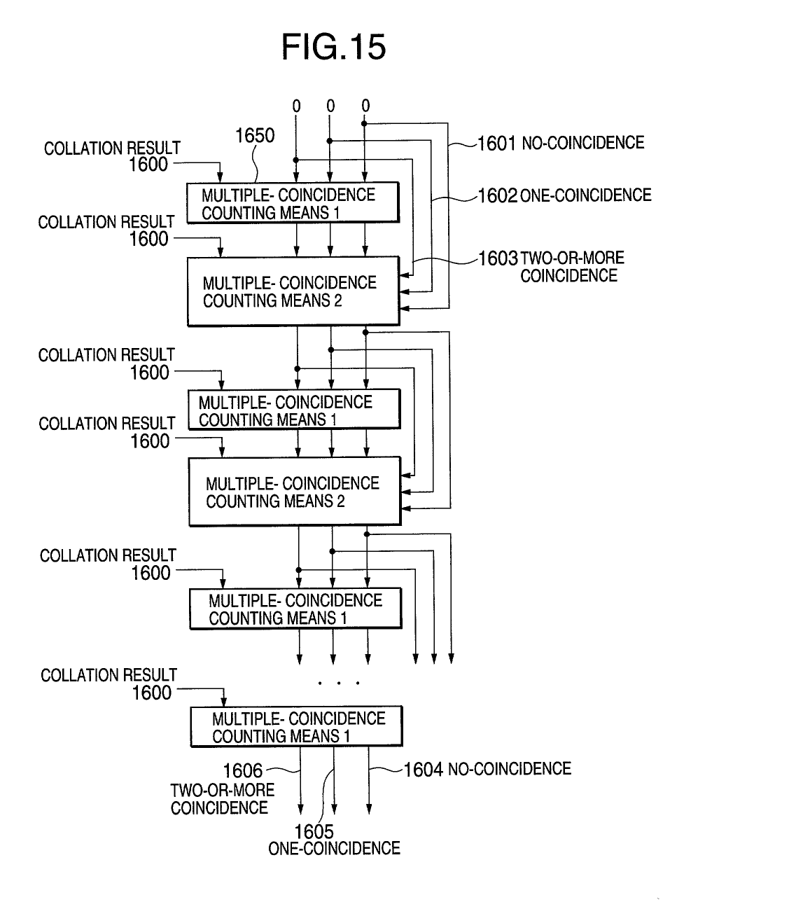

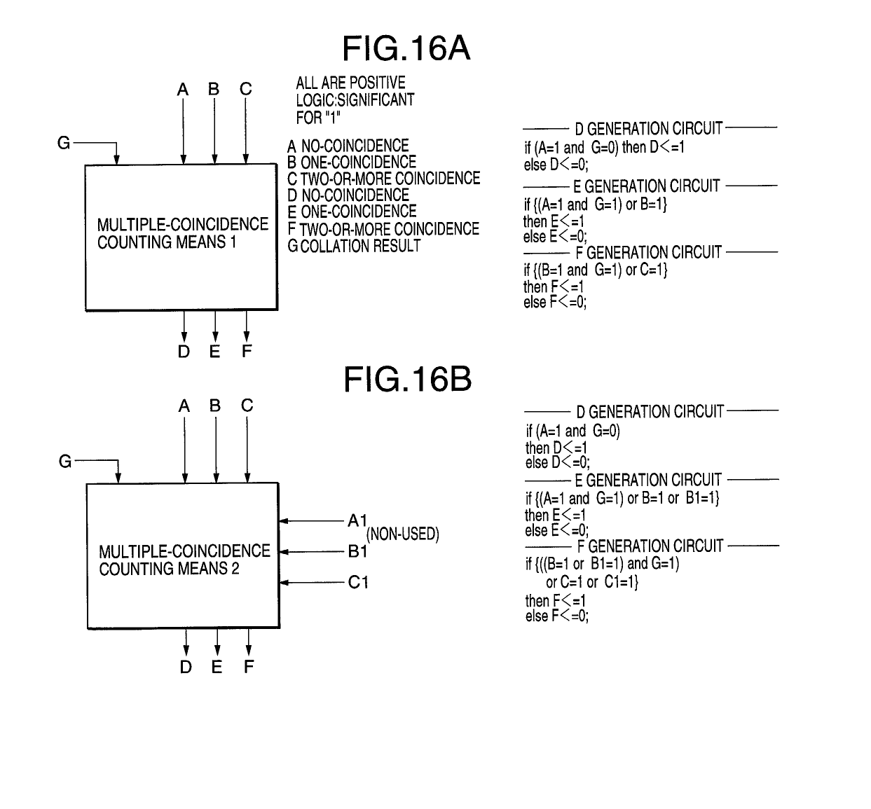

A thirteenth embodiment of the present invention will be described hereinbelow with reference to FIGS. 15, 16A and 16B. FIG. 15 is an illustration of an arrangement for detection of multiple-coincidence of entry data stored in an entry data storage means 150. In this arrangement, a plurality of multiple-coincidence counting means 1650 equal in number to entries are arranged in a multi-stage fashion. The first multiple-coincidence counting means 1650 positioned in other than multiples of 2 detects the coincidence with a plurality of entry data on the basis of a collation result 1600 for each entry data, and no-coincidence information 1601, one-coincidence information 1602 and two-or-more coincidence information 1603 which are multiple-coincidence information on an intermediate result up to a previous stage, and communicates the detection result to the next-stage multiple-coincidence counting means. In addition, the second multiple-coincidence counting means 1650 positioned in a multiple of 2 detects the coincidence with a plurality of entry data on the basis of the collation result 1600 for each entry data, the multiple-coincidence information 1601, 1602, 1603 up to the last stage and the multiple-coincidence information 1601, 1602, 1603 up to the last-but-one stage, and communicates the detection result to the next-stage and next-but-one multiple-coincidence counting means 1650. Still additionally, the final-stage multiple-coincidence counting means 1650 outputs, as the final result, the no-coincidence information 1604, the one-coincidence information 1605 and the two-or-more coincidence information.

FIG. 16A is an illustration useful for explaining an operation of the first multiple-coincidence counting means 1650. In the case of the last (up to the previous stage) no-coincidence input A=1 and collation result G=0, the first multiple-coincidence counting means 1650 supplies the no-coincidence output D=1, while in other cases, it outputs D=0. In addition, in the case of the last no-coincidence input A=1 and collation result G=1, or if the last one-coincidence input B=1, it gives the one-coincidence output E=1, while in other cases, it outputs E=0. Still additionally, in the case of the last one-coincidence input B=1 and collation result G=1, or if the last two-or-more coincidence input C=1, it gives the two-or-more coincidence output F=1, while in other cases, it outputs F=0.

FIG. 16B is an illustration useful for explaining an operation of the second multiple-coincidence counting means 1650. In the case of the last no-coincidence input A=1 and collation result G=0, the second multiple-coincidence counting means 1650 supplies the no-coincidence output D=1, while in other cases, it outputs D=0. Moreover, in the case of the last no-coincidence input A=1 and collation result G=1, or if the last one-coincidence input B=1 or the last-but-one one-coincidence input B1=1, it gives the one-coincidence output E=1, while in other cases, it outputs E=0. Still moreover, in addition to the last one-coincidence input B=1 or the last-but-one one-coincidence input B1=1 and the collation result G=1, in the case of the last two-or-more coincidence input C=1 or the last-but-one two-or-more coincidence input C1=1, it gives the two-or-more coincidence output F=1, while in other cases, it outputs F=0.

In this case, when the number of entries is taken to be E and a delay time required from the input to the output in one multiple-coincidence counting means 1650 is taken as T, in the case of the employment of a method of detecting the multiple-coincidence according to an ordinary sequence, the maximum gate delay time becomes E×T, whereas this method according to this embodiment can suppress the maximum gate delay time to approximately (1/2×E+2)×T.

Incidentally, in the example of FIG. 15, although the multiple-coincidence information is communicated to the next-but-one stage, it is also possible that the communication of the multiple-coincidence information is made at intervals of N (with respect to multiples of N). Also in this case, similar effects are attainable, that is, the maximum gate delay time assumes approximately (1/N×E+2×N−2)×T.

Fourteenth Embodiment

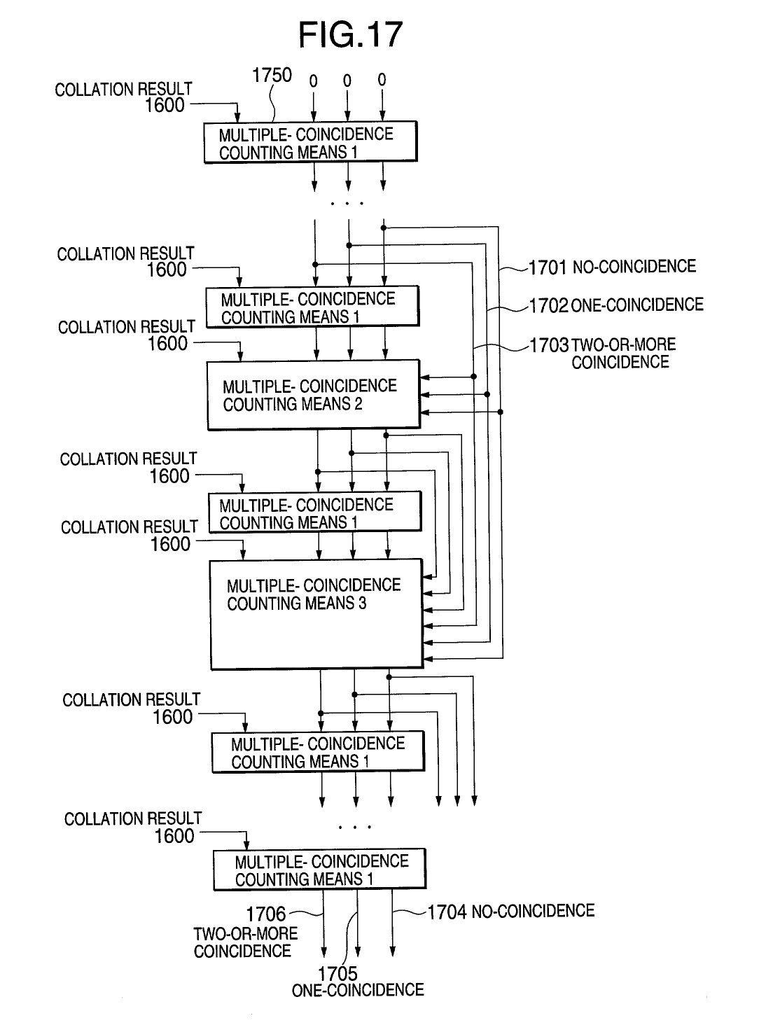

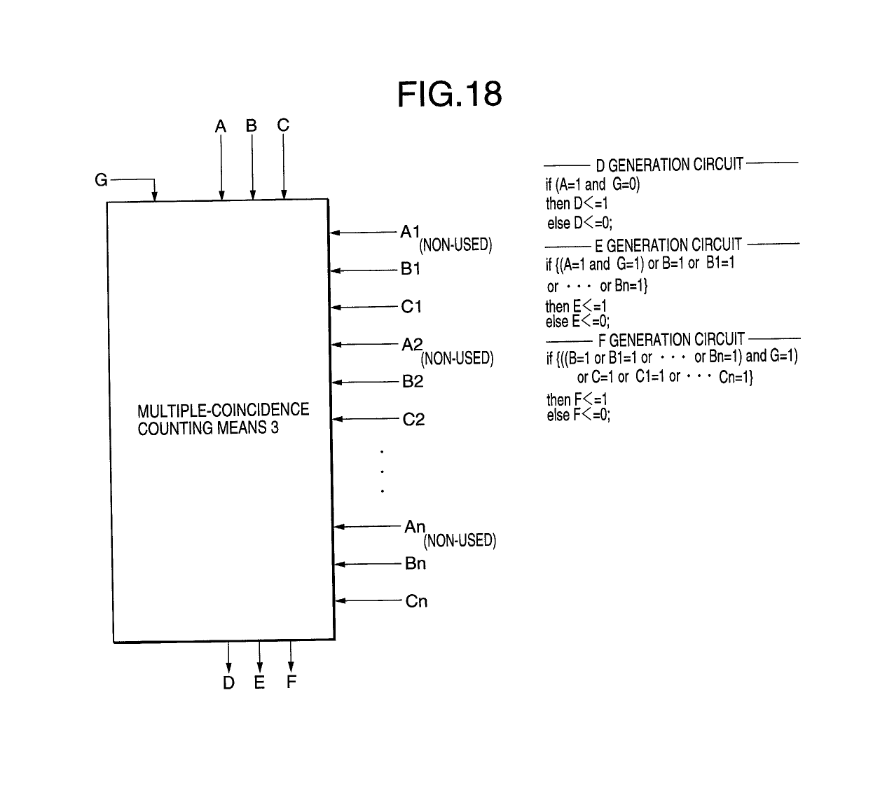

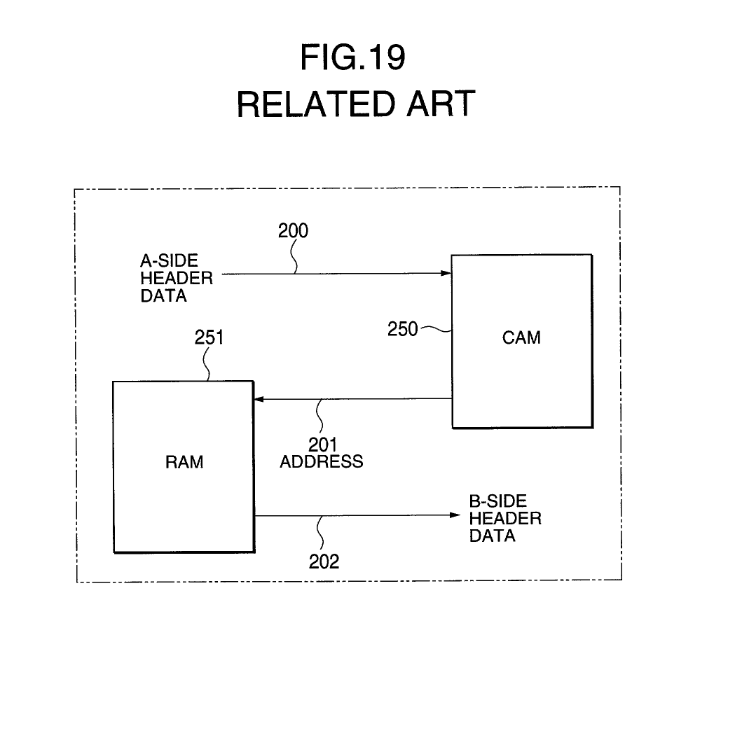

A fourteenth embodiment of the present invention will be described hereinbelow with reference to FIGS. 17 and 18. FIG. 17 is an illustration of an arrangement in which a plurality of multiple-coincidence counting means 1750 equal in number to entries are arranged in a multi-stage fashion.

The multiple-coincidence counting means 1750 positioned in other than the Mth power of 2 (M represents a natural number) have the same configuration as that shown in FIG. 16A, and detect the coincidence with a plurality of entry data on the basis of collation result 1600 for each entry data and no-coincidence information 1701, one-coincidence information 1702 and two-or-more coincidence information 1703 which are the last multiple-coincidence information to communicate the detection result to the next multiple-coincidence counting means 1750.

Furthermore, the multiple-coincidence counting means 1750 positioned in the Mth power of 2 detect the coincidence with a plurality of entry data on the basis of the collation result 1600 for each entry data, the last-stage collation results 1701 to 1703 and the last-but-2^{T}-1 (T represents all natural numbers below M) collation results 1701 to 1703, and communicate the detection result to the next multiple-coincidence counting means and the next-but-2^{T}-1 multiple-coincidence counting means 1750. In addition, the final-stage multiple-coincidence counting means 1750 outputs no-coincidence information 1704, one-coincidence information 1705 and two-or-more coincidence information 1706 as the final result.

FIG. 18 is an illustration useful for explaining an operation of the multiple-coincidence counting means 1750. This multiple-coincidence counting means 1750 gives the no-coincidence output D=1 when the last no-coincidence input A=1 and collation result G=0, while outputting D=0 in other cases. Moreover, it provides the one-coincidence output E=1 when the last no-coincidence input A=1 and collation result G=1, or when the last one-coincidence input B=1 or any one of the last-but-2^{T}-1 one-coincidence inputs is “1”, while outputting E=0 in other cases. Still moreover, it provides the two-or-more coincidence output F=1 when the last one-coincidence input B=1 or any one of the last-but-2^{T}-1 one-coincidence inputs is “1” and the collation result G=1 and when the last two-or-more coincidence input C=1 or any one of the last-but-2^{T}-1 one-coincidence inputs is “1”, while outputting F=0 in other cases.

In this case, when the number of entries is taken to be E and a delay time required from the input to the output in one multiple-coincidence counting means 1750 is taken as T, in the case of the employment of a method of detecting the multiple-coincidence according to an ordinary sequence, the maximum gate delay time becomes E×T, whereas this method according to this embodiment can suppress the maximum gate delay time to approximately log₂ E×T.

Incidentally, in the example of FIG. 17, although the multiple-coincidence information is communicated to the next-but-(power-of-2)-1 stage, it is also possible that the communication of the multiple-coincidence information is made to the (power-of-N)-1 stage. Also in this case, similar effects are attainable, that is, the maximum gate delay time assumes approximately (log_{N} E+2×N)×T.

It should be understood that the present invention is not limited to the above-described embodiment, and that it is intended to cover all changes and modifications of the embodiments of the invention herein which do not constitute departures from the spirit and scope of the invention.

What is claimed is:

1. An ATM header conversion circuit comprising:
entry data storage means for storing, as entry data, first and second ATM header data paired at each of a plurality of addresses;
partial collation means for partially collating inputted header data with one of said first and second ATM header data stored in said entry data storage means for each address on the basis of a designation signal representative of a collation position of said ATM header data being converted, and for outputting a collation result for each address;
address extraction means for extracting, on the basis of the collation result for each address, an address in said entry data storage means at which the collation result shows coincidence; and
header outputting means for outputting, as converted ATM header data, the other of said first and second ATM header data at said address extracted by said address extraction means, from said entry data storage means.

2. The ATM header conversion circuit according to claim 1, wherein said designation signal representative of the collation position of one of said first and second ATM header data is generated in units of bits, and said partial collation means collates said inputted header data with one of said first and second ATM header data in units of bits.

3. The ATM header conversion circuit according to claim 1, wherein said designation signal representative of the collation position of one of said first and second ATM header data is generated in unit of word, and said partial collation means collates the inputted header data with one of said first and second ATM header data in unit of word.

4. The ATM header conversion circuit according to claim 1, further comprising entry data partial-readout means for partially reading out, in the form of one word, one of said first or second ATM header data stored in said entry data storage means on the basis of a designation signal generated in the form of word and a specified readout address in said entry data storage means.

5. The ATM header conversion circuit according to claim 1, further comprising entry data partial-write means for partially writing, in the form of one word, one of first and second ATM header data in said entry data storage means on the basis of a designation signal generated in unit of word and a write address in said entry data storage means.

6. The ATM header conversion circuit according to claim 3, wherein the number of words each to be used for said designation signal is made variable.

7. The ATM header conversion circuit according to claim 3, wherein the number of bits to be allocated to one word is made variable.

8. The ATM header conversion circuit according to claim 3, wherein the number of words each to be used for the designation signal and the number of bits to be allocated to one word are made variable.

9. The ATM header conversion circuit according to claim 1, wherein said header outputting means is made to output, in addition to said converted ATM header data, a corresponding address in said entry data storage means.

10. An ATM header conversion circuit comprising:
entry data storage means for storing ATM header data, which remain unchanged before and after conversion, as entry data in a state associated with first and second addresses paired;
full collation means for fully collating inputted header data with said ATM header data, stored in said entry data storage means, at each of said pairs of first and second addresses to output a collation result at each of said pairs of first and second addresses;
address extraction means for extracting, on the basis of said collation result at each of said pairs of first and second addresses, said first and second addresses in said entry data storage means at which said collation result shows coincidence;
converted ATM header storage means for previously storing said ATM header data after conversion in a state associated with said first and second addresses in said entry data storage means; and
readout means for selecting one of said first and second addresses extracted in said address extraction means on the basis of a direction of the ATM header conversion to read out said ATM header data at the selected address from said converted ATM header storage means.

11. The ATM header conversion circuit according to claim 10, wherein said ATM header conversion direction is designated according to a network through which header data is inputted to said full collation means.

12. The ATM header conversion circuit according to claim 1, further comprising a connection whose one side has a plurality of divided ports so that addresses in said entry data storage means correspond to the numbers of said ports, respectively.

13. The ATM header conversion circuit according to claim 10, further comprising a connection whose one side has a plurality of divided ports so that addresses in said entry data storage means correspond to the numbers of said ports, respectively.

14. The ATM header conversion circuit according to claim 1, further comprising a connection whose one side has a plurality of divided ports, and addresses in said entry data storage means include the numbers of said ports, respectively.

15. The ATM header conversion circuit according to claim 10, further comprising a connection whose one side has a plurality of divided ports, and addresses in said entry data storage means include the numbers of said ports, respectively.

16. The ATM header conversion circuit according to claim 14, wherein header data inputted through one non-divided side of said connection is collated on the basis of said designation signal representative of the collation position of said ATM header data being converted, and said ATM header data converted is outputted to one of said plurality of divided ports of the other side of said connection on the basis of said port number included in said address.

17. The ATM header conversion circuit according to claim 14, wherein said port numbers are added to said ATM header data on the divided side of said connection and stored in said entry data storage means, and said ATM header data and said port numbers are partially collated on the basis of said designation signal representative of the collation position of said ATM header data being converted.

18. The ATM header conversion circuit according to claim 14, wherein said port numbers are added to said ATM header data on the divided side of said connection and stored in said entry data storage means while said ATM header data on the non-divided side of said connection is stored intact, and in a case in which said ATM header data is inputted through the divided side of said connection, said ATM header data, together with said port number, is partially collated on the basis of said designation signal representative of the collation position of said ATM header data being converted, while in a case in which said ATM header data is inputted through the non-divided side of said connection, only said ATM header data undergoes partial collation.

19. The ATM header conversion circuit according to claim 1, wherein connection information is added to said entry data and stored in said entry data storage means.

20. The ATM header conversion circuit according to claim 19, wherein said connection information, together with the converted header data corresponding to said inputted header data, is outputted on the basis of said designation signal representative of the collation position of said ATM header data being converted.

21. The ATM header conversion circuit according to claim 1, wherein, of said ATM header data stored in said entry data storage means, a VPI/VCI inhibited as input in a system is set as an initial value.

22. The ATM header conversion circuit according to claim 10, wherein, of said ATM header data stored in said entry data storage means, a VPI/VCI inhibited as input in a system is set as an initial value.

23. The ATM header conversion circuit according to claim 1, wherein, of said ATM header data stored in said entry data storage means, a VPI/VCI which is not required to be registered is set as an initial value.

24. The ATM header conversion circuit according to claim 10, wherein, of said ATM header data stored in said entry data storage means, a VPI/VCI which is not required to be registered is set as an initial value.

25. The ATM header conversion circuit according to claim 1, further comprising:
first multiple-coincidence counting means placed in an odd-number position for counting the coincidences with a plurality of entry data on the basis of a collation result on each entry data stored in said entry data storage means and the last multiple-coincidence information on said entry data and further for communicating a count result to the next multiple-coincidence counting means; and
second multiple-coincidence counting means placed in an even-number position for detecting the coincidences with a plurality of entry data on the basis of a collation result on each entry data stored in said entry data storage means, the last multiple-coincidence information and the last-but-one multiple-coincidence information, and further for communicating a detection result to the next multiple-coincidence counting means and the next-but-one multiple-coincidence counting means.

26. The ATM header conversion circuit according to claim 10, further comprising:
first multiple-coincidence counting means placed in an odd-number position for counting the coincidences with a plurality of entry data on the basis of a collation result on each entry data stored in said entry data storage means and the last multiple-coincidence information on said entry data and further for communicating a count result to the next multiple-coincidence counting means; and
second multiple-coincidence counting means placed in an even-number position for detecting the coincidences with a plurality of entry data on the basis of a collation result on each entry data stored in said entry data storage means, the last multiple-coincidence information and the last-but-one multiple-coincidence information, and further for communicating a detection result to the next multiple-coincidence counting means and the next-but-one multiple-coincidence counting means.

27. The ATM header conversion circuit according to claim 1, further comprising:
first multiple-coincidence counting means placed in other than position in multiples of a natural number N for detecting the coincidences with a plurality of entry data on the basis of a collation result on each entry data stored in said entry data storage means and the last multiple-coincidence information on said entry data and further for communicating a detection result to the next multiple-coincidence counting means; and
second multiple-coincidence counting means placed in a multiple-of-N position for detecting the coincidences with a plurality of entry data on the basis of a collation result on each entry data stored in said entry data storage means, the last multiple-coincidence information and the last-but-N-1 multiple-coincidence information, and further for communicating a detection result to the next multiple-coincidence counting means and the next-but-N-1 multiple-coincidence counting means.

28. The ATM header conversion circuit according to claim 10, further comprising:
first multiple-coincidence counting means placed in other than position in multiples of a natural number N for detecting the coincidences with a plurality of entry data on the basis of a collation result on each entry data stored in said entry data storage means and the last multiple-coincidence information on said entry data and further for communicating a detection result to the next multiple-coincidence counting means; and
second multiple-coincidence counting means placed in a multiple-of-N position for detecting the coincidences with a plurality of entry data on the basis of a collation result on each entry data stored in said entry data storage means, the last multiple-coincidence information and the last-but-N-1 multiple-coincidence information, and further for communicating a detection result to the next multiple-coincidence counting means and the next-but-N-1 multiple-coincidence counting means.

29. The ATM header conversion circuit according to claim 1, further comprising:
first multiple-coincidence counting means placed in other than position in the Mth power of 2 (M represents a natural number) for detecting the coincidences with a plurality of entry data on the basis of a collation result on each entry data stored in said entry data storage means and the last multiple-coincidence information on said entry data and further for communicating a detection result to the next multiple-coincidence counting means; and
second multiple-coincidence counting means placed in a position in the Mth power of 2 for detecting the coincidences with a plurality of entry data on the basis of a collation result on each entry data stored in said entry data storage means, the last multiple-coincidence information and the last-but-2^{T}-1 (T represents all natural numbers below M) multiple-coincidence information, and further for communicating a detection result to the next multiple-coincidence counting means and the next-but-2^{T}-1 multiple-coincidence counting means.

30. The ATM header conversion circuit according to claim 10, further comprising:
first multiple-coincidence counting means placed in other than position in the Mth power of 2 (M represents a natural number) for detecting the coincidences with a plurality of entry data on the basis of a collation result on each entry data stored in said entry data storage means and the last multiple-coincidence information on said entry data and further for communicating a detection result to the next multiple-coincidence counting means; and
second multiple-coincidence counting means placed in a position in the Mth power of 2 for detecting the coincidences with a plurality of entry data on the basis of a collation result on each entry data stored in said entry data storage means, the last multiple-coincidence information and the last-but-2^{T}-1 (T represents all natural numbers below M) multiple-coincidence information, and further for communicating a detection result to the next multiple-coincidence counting means and the next-but-2^{T}-1 multiple-coincidence counting means.

31. The ATM header conversion circuit according to claim 1, further comprising:
first multiple-coincidence counting means placed in other than position in the Mth power of N (M, N represent a natural number) for detecting the coincidences with a plurality of entry data on the basis of a collation result on each entry data stored in said entry data storage means and the last multiple-coincidence information on said entry data and further for communicating a detection result to the next multiple-coincidence counting means; and
second multiple-coincidence counting means placed in a position in the Mth power of N for detecting the coincidences with a plurality of entry data on the basis of a collation result on each entry data stored in the entry data storage means, the last multiple-coincidence information and the last-but-N^{T}-1 (T represents all natural numbers below M) multiple-coincidence information, and further for communicating a detection result to the next multiple-coincidence counting means and the next-but-N^{T}-1 multiple-coincidence counting means.

32. The ATM header conversion circuit according to claim 10, further comprising:
first multiple-coincidence counting means placed in other than position in the Mth power of N (M, N represent a natural number) for detecting the coincidences with a plurality of entry data on the basis of a collation result on each entry data stored in said entry data storage means and the last multiple-coincidence information on said entry data and further for communicating a detection result to the next multiple-coincidence counting means; and
second multiple-coincidence counting means placed in a position in the Mth power of N for detecting the coincidences with a plurality of entry data on the basis of a collation result on each entry data stored in the entry data storage means, the last multiple-coincidence information and the last-but-N^{T}-1 (T represents all natural numbers below M) multiple-coincidence information, and further for communicating a detection result to the next multiple-coincidence counting means and the next-but-N^{T}-1 multiple-coincidence counting means.

33. An ATM header conversion method for an optical subscriber transmission system, comprising the steps of:
storing, as entry data, first and second ATM header data paired at each of a plurality of addresses;
partially collating inputted header data with one of said first and second ATM header data stored by said storing step for each address on the basis of a designation signal representative of a collation position of said ATM header data being converted;
outputting a collation result for each address;
extracting, on the basis of the collation result for each address, an address, stored by said storing step, at which the collation result shows coincidence; and
outputting, as converted ATM header data, the other of said first and second ATM header data at said address extracted by said extracting step.

34. An ATM header conversion method for an optical subscriber transmission system, comprising the steps of:
storing ATM header data, which remain unchanged before and after conversion, as entry data in a state associated with first and second addresses paired;
fully collating inputted header data with said ATM header data, stored by said storing step, at each of said pairs of first and second addresses to output a collation result at each of said pairs of first and second addresses;
extracting, on the basis of said collation result at each of said pairs of first and second addresses, said first and second addresses storied by said storing step at which said collation result shows coincidence;
storing in advance, in a converted ATM header storage means, said ATM header data after conversion in a state associated with said first and second addresses stored by said storing step; and
selecting one of said first and second addresses extracted by said extracting step on the basis of a direction of the ATM header conversion to read out said ATM header data at the selected address from said converted ATM header storage means.

35. An ATM header conversion method, comprising the steps of:
storing first and second ATM header data in a state paired with respect to each of a plurality of addresses;
collating inputted header data with one of the stored first and second ATM header data at each address on the basis of a collation position of said ATM header data being converted
selecting the other of said first and second ATM header data at an address where a collation result shows coincidence as converted ATM header data.
